(19) United States
(12) Patent Application Publication
(10) Pub. No.: US 2017/0282511 A1
(43) Pub. Date: Oct. 5, 2017

(54) AIR-PERMEABLE LAMINATE INSULATION MATERIAL

(71) Applicant: Chang Yeon HWANG, Daejeon (KR)

(72) Inventor: Chang Yeon HWANG, Daejeon (KR)

(21) Appl. No.: 15/507,224

(22) PCT Filed: Aug. 27, 2015
(86) PCT No.: PCT/KR2015/008959

§ 371 Date: Feb. 27, 2017

(30) Foreign Application Priority Data
Aug. 29, 2014 (KR) 10-2014-0114003

(51) Int. Cl. B32B 27/12; B32B 27/32; B32B 17/02; B32B 27/20; B32B 15/20; B32B 15/14

(52) U.S. Cl. CPC B32B 27/12; B32B 15/20; B32B 15/14; B32B 17/02; B32B 27/20; B32B 27/32; B32B 2307/724

(57) ABSTRACT

The present invention relates to an air-permeable laminate insulation material, and more specifically, to an air-permeable laminate insulation material including: an insulation material layer; an aluminum coating layer formed on one or both surfaces of the insulation material layer; a non-woven fabric layer formed on the aluminum coating layer; and a polyolefin composite layer which is made from a mixture of polyolefin and inorganic particles and laminated on top of the non-woven fabric layer.

### TECHNICAL FIELD

The present invention relates to an air-permeable laminate insulation material, and more particularly, to an air-permeable laminate insulation material capable of keeping air permeability, having reinforced strength, and preventing moisture or a drop of water from being permeated by laminating an insulation material layer; an aluminum coating layer; a non-woven fabric layer; and a polyolefin composite layer, thereby keeping water-proof property, insulation, and moisture permeability of buildings.

### BACKGROUND ART

Generally, a vinyl house is produced by taking a tunnel-shaped frame by bending an iron pipe or the like and covering vinyl films, such as a vinyl chloride film and a polyethylene film, over the tunnel-shaped frame. The vinyl house has been mainly used for cultivation of vegetables, flowers, and fruits and in livestock industries. In particular, there are various types and standard specifications for farmhouse type vinyl houses designed considering weather disasters such as heavy snow, strong wind and cold wave. As a result, sizes and materials suitable for each usage of vinyl houses are recommended.

In addition, since vinyl houses are mostly used for insulation, they are heated by a method of increasing an internal temperature by operating a boiler or a hot air fan in the winter when which a temperature is low. For this purpose, the heating is generally made by burning underground resources, such as solid fuels (coal, briquettes, etc.), liquid fuels (oil, etc.), and gas fuels (gas, etc.), to generate heat or by operating a heater or a hot air fan with electricity.

In this case, however, there is a problem in that all of maintenance costs are high and as a result costs for crops of cultivation increase, such that price competitiveness of products may be low, in the case of using solid fuels and liquid fuels, additional facilities for emitting harmful gases to a human body, which are generated during the combustion of the fuels, to the outside are required, and in the case of using electricity, management is easy but it costs a lot of electricity rate, and as a result efficiency decreases.

In particular, since the heat is generated only locally in the above-mentioned heating, a separate air conditioning facility is required to supply warmth to the entire vinyl house and it is difficult to evenly raise and keep a temperature at once.

Also, in the season when heating is not required, the heat insulation is achieved simply by covering the non-woven fabric to prevent a cold-weather damage. However, in the case of using the non-woven fabric, since the vinyl house is always not covered with the non-woven fabric but it is necessary to repeat a process of covering the vinyl house with the non-woven fabric at night and again taking off the non-woven fabric in consideration of sunshine in the daytime, the process is complicated and therefore the management is not easy, and since the non-woven fabric is located outside the vinyl house, the non-woven fabric is liable to be lost due to external environment (rain, snow, friction, external force, etc.) over time, and therefore there is a burden due to the replacement and it is difficult to treat wastes generated after the replacement.

As an improved method for insulation of a vinyl house, Korean Patent No. 10-0877790 (Jan. 2, 2009) discloses a technology of making vinyl for a vinyl house including a sheet heater having a predetermined width along a longitudinal direction of coated vinyl used for production of a vinyl house to produce the vinyl house with the vinyl for the vinyl house and applying power to the sheet heater to keep a temperature in a vinyl house.

Further, Korean Utility Model Publication No. 1990-0002728 (Mar. 31, 1990) discloses a method for insulation of a vinyl house, in which a protective cover for a vinyl house produced by laminating a thin plate-like insulation material made of styrofoam, urethane, or the like between typical bubble films and on both sides thereof, bonding a synthetic resin fabric to both surfaces of the insulation material, coating a surface thereof with a synthetic resin film, and the like is known. However, there is a problem in that the above-mentioned method requires a labor-intensive operation of taking off the protective cover to get sunlight in the daytime and again covering the protective cover at night.

As a technique to overcome the problems, Korean Patent No. 10-0770694 (Oct. 22, 2007) discloses insulation vinyl for a vinyl house capable of maximizing an insulation effect in the vinyl house by continuously circulating hot air between double vinyl installed in a vinyl house frame in an intersecting direction.

In the case of vinyl houses which are mostly used in small farmhouses and are generally heat insulated with only a single layer of vinyl, the heat in the vinyl house is easily lost to the outside, and as a result a considerable amount of heat loss occurs. In order to prevent the heat loss, there is a need to cover the vinyl house with a heat insulation material. However, it costs extra due to the heat insulation material and it costs a lot due to a considerable amount of fuel and electricity consumed to raise the temperature in the vinyl house, and therefore there is a problem in that complicated construction and investment cost in facility are burden on small farmhouses, or the like. In addition, a vinyl sheet for the vinyl house is used while overlapping in multiple layers, which makes it difficult to realize a rigid vinyl house structure and leads to the decrease in the insulation effect. However, to increase the heat insulation and the durability, the vinyl house may be formed in a double structure, which causes a problem that the frame needs to be installed doubly and the vinyl also needs to be installed doubly.

To improve the above problems, Korean Patent No. 10-0918608 (Sep. 16, 2009) discloses a technology of attaching a reinforcing member having an air pocket to plural layers of vinyl sheets to prevent vinyl from being damaged by an impact of a hail, etc., using an air layer included in the air pocket to increase an insulation effect, and making a vinyl structure of a vinyl house rigid by additionally including a reinforcing mesh and a heater.

Although many methods and materials have been disclosed for increasing the insulation and durability of the vinyl house widely used in the agricultural field, all of the above-mentioned existing methods still have a problem in that a separate power supply or energy source needs to be continuously operated to keep the temperature in the vinyl house and the structure is complicated and thus the installation and the management are also complicated and it costs a lot.

### DISCLOSURE

### Technical Problem

An object of the present invention is to provide an air-permeable laminate insulation material capable of having excellent air permeability and reinforced strength by performing thermal adhesion on an insulation material layer, an aluminum coating layer coated with a solution including aluminum particles, a non-woven fabric layer, and a polyolefin composite layer made from a mixture of polyolefin resin and inorganic particles or performing adhesion on them by spray coating an adhesive thereon.

Another object of the present invention is to provide an air-permeable laminate insulation material capable of preventing a condensation, having excellent tensile strength and adhesion, and being easily constructed.

### Technical Solution

In one general aspect, an air-permeable laminate insulation material includes: an insulation material layer; an aluminum coating layer formed on one or both surfaces of the insulation material layer; a non-woven fabric layer formed on the aluminum coating layer; and a polyolefin composite layer which is made from a mixture of polyolefin resin and inorganic particles and laminated on the non-woven fabric layer.

Further, reference is made to FIGS. 1 and 2 as a more preferable example of the present invention.

First, FIG. 1 illustrates an air-permeable laminate insulation material according to an aspect of the present invention, in which the air-permeable laminate insulation material includes an aluminum coating layer 20 formed on one surface of an insulation material layer 10, a non-woven fabric layer 30 formed on the aluminum coating layer 20, and a polyolefin composite layer 40 laminated on the non-woven fabric layer 30.

FIG. 2 illustrates an air-permeable laminate insulation material according to another aspect of the present invention, in which the air-permeable laminate insulation material includes the aluminum coating layer 20 formed on both surfaces of the insulation material layer 10, the non-woven fabric layer 30 formed on the aluminum coating layer 20, and the polyolefin composite layer 40 laminated on the non-woven fabric layer 30.

Hereinafter, the air-permeable laminate insulation material of the present invention will be described in more detail.

The present invention relates to an air-permeable laminate insulation material including: the insulation material layer 10; the aluminum coating layer 20 formed on one or both surfaces of the insulation material layer 10; the non-woven fabric layer 30 formed on the aluminum coating layer 20; and the polyolefin composite layer 40 which is made from a mixture of polyolefin resin and inorganic particles and laminated on the non-woven fabric layer 30.

The insulation material layer 10 may be formed using an insulation material to improve heat insulating property and insulation. In detail, the insulation material may be made of any one or two or more selected from the group consisting of, for example, cotton, needle punching non-woven fabric, plastic foam, melt blown non-woven fabric, polyolefin non-woven fabric, polyolefin resin, fiber fabric, woven fabric, etc. A basis weight of the insulation material layer 10 ranges from 25 to 800 g/m², preferably 100 to 300 g/m², more preferably 100 to 200 g/m², for the purpose of achieving the heat insulating property and the insulation of the air-permeable laminate insulation material, but is not limited thereto.

The aluminum coating layer 20 may be formed by coating or depositing a solution including aluminum particles or may be formed by thermally pressing an aluminum foil or bonding it with an adhesive in order to increase an insulation effect due to heat reflection and completely block heat in a vinyl house from being discharged to the outside. In particular, when the aluminum coating layer 20 is formed by coating or depositing the solution including the aluminum particles on the insulation material layer 10, the air-permeable laminate insulation material having the increased insulation effect and excellent tensile strength, breaking strength, and air permeability may be prepared. Further, when the aluminum coating layer 20 is formed by coating or depositing the solution including the aluminum particles compared with using the aluminum foil, the aluminum coating layer 20 having the increased insulation effect and more excellent tensile strength, breaking strength, and air permeability may be produced.

More specifically, the aluminum coating layer 20 may use a solution in which aluminum powder having a particle size of 8 to 15 μm is dispersed in an organic solvent. Here, it is preferable to use the aluminum having the particle size of 8 to 15 μm in order to simultaneously satisfy moisture permeability and heat reflectance.

The organic solvent is not particularly limited as long as it may disperse the aluminum powder. A specific example of the organic solvent may include a mixed solvent of any one or two or more selected from the group consisting of toluene, methylene chloride, chloroform, hexane, benzene, xylene, butyl acetate, methyl acetate, methyl isobutyl ketone, etc.

For the coating, as a specific example, screen coating or gravure coating may be used. The aluminum coating layer 20 may be preferably coated within a basis weight of 1 to 80 g/m², preferably 1 to 40 g/m² in order to completely block heat from being discharged to the outside and achieve the high heat insulating effect.

The non-woven fabric layer 30 enhances the tensile strength which is a mechanical property and serves to prevent tearing, or the like from occurring. Further, as the non-woven fabric of the non-woven fabric layer 30 of the present invention, any selected from non-woven fabric produced by spun bond, spun lace, or needle punch, or the like or a non-woven fabric or a mesh film, or a fiber fabric may be used, but the non-woven fabric of the non-woven fabric layer 30 is not necessarily limited thereto. Preferably, it is preferable to spin polyester-based or polyolefin-based filament fiber in order to attain the excellent air permeability, obtain the desired strength, and prevent the tearing. The non-woven fabric may be produced by being laminated in a multi-layer web and thermally bonded or by the needle punching on a belt continuously moving so that the basis weight of the non-woven fabric layer is 10 to 60 g/m², but the preparing of the non-woven fabric is not necessarily limited thereto.

The polyolefin composite layer 40 may be produced by producing an extrusion sheet by adding the inorganic particles to the polyolefin resin and stretching the extrusion sheet, thereby improving the water-proof property and the air permeability. As a specific example of the polyolefin resin, a mixture of any one or two or more selected from an ethylene-α-olefin copolymer resin, a low-density polyethylene resin, and an ethylene-vinyl acetate copolymer resin may be used. In the case of using the ethylene-α-olefin copolymer resin, an ethylene-α-olefin copolymer resin having a density of 0.895 to 0.940 g/cm³ and a melt index of 0.8 to 5.0 g/10 min (190° C., 2.16 kg) is used for the flexibility of the film. Further, as α-olefin of the ethylene-α-olefin copolymer resin, any one selected from the group consisting of butene, hexene and octene may be used. In the case of using the low-density polyethylene resin, a low-density polyethylene resin having a density of 0.9 to 0.95 g/cm³ and a melt index of 2.5 to 7 g/10 min (190° C., 2.16 kg) may be used. Further, in the case of using the ethylene-vinyl acetate copolymer resin, an ethylene-vinyl acetate copolymer resin having a vinyl acetate content of 5% or more, a density of 0.910 to 0.940 g/cm³ and a melt index of 1 to 4 g/10 min (190° C., 2.16 kg) may be used.

In the case of using a mixture of two or more of the polyolefin resins, if the amount of the low-density polyethylene is large, film formability is increased but the tensile strength and elongation properties may deteriorate. Further, when the amount of the ethylene-vinyl acetate copolymer resin is increased, the ethylene-vinyl acetate copolymer resin increased to a certain amount helps improve the dispersion of the inorganic particles, but the ethylene-vinyl acetate copolymer resin exceeding the certain amount does not help improve the dispersion and may cause the decrease in the tensile strength and the elongation properties.

Preferably, the ethylene-vinyl acetate copolymer resin selected from the group consisting of polypropylene, low density polyethylene, high density polyethylene, linear low density polyethylene, and medium density polyethylene may be used. The polyolefin resin is not particularly limited as long as it has a molecular weight enough to form a film. However, in the present invention, it is preferable to use a polyolefin resin having a melt index of 1 to 7 g/10 min (190° C., 2.16 kg) in order to keep mechanical properties, air permeability, and moisture permeability.

The inorganic particles may use one or two or more selected from the group consisting of calcium carbonate, silica, clay talc, talc, barium sulfate, alumina, and zeolite, but are not necessarily limited thereto. An average particle diameter of the inorganic particles may be selected according to the purpose of the invention. For the purpose of the moisture permeability, the air permeability, and the mechanical strength, the average particle diameter of the inorganic particles may range from 0.5 to 30 μm, more preferably 0.7 to 5.0 μm.

The content thereof is adjusted as necessary. For example, 10 to 200 parts by weight, preferably 10 to 150 parts by weight, more preferably 30 to 100 parts by weight of the inorganic particles with respect to 100 parts by weight of the polyolefin resin are preferably used to improve flexural strength, elasticity, and flexibility. The polyolefin composite layer 40 preferably has a basis weight of 10 to 100 g/m² not to be easily torn and to keep the air permeability and the moisture permeability.

Further, in the present invention, the non-woven fabric layer 30 and the polyolefin composite layer 40 may be thermally bonded by a hot roller or may be bonded by further having an air-permeable adhesive layer provided between the non-woven fabric layer 30 and the polyolefin composite layer 40.

The air-permeable adhesive layer may be formed by applying an adhesive on the non-woven fabric layer 30 or the polyolefin composite layer 40 and preferably has a basis weight of 1 to 10 g/m² for the excellent adhesion and air permeability. The air-permeable adhesive layer may be formed by the spray coating or the gravure roll coating to uniformly coat the adhesive and keep the air permeability. By the spray coating or the gravure roll coating, the air-permeable adhesive layer has the coated portion and the uncoated portion of the adhesive, thereby more improving the air permeability.

The adhesive is not limited thereto. Among urethane adhesives, for example, a hot-melt adhesive or a one component type solvent type adhesive may be used. As a specific example, the hot-melt adhesive may include 50 to 55 wt % of polyolefin based resin of one or two or more selected from the group consisting of polyethylene, polypropylene, polybutylene, ethylene-propylene copolymer, and propylene-butylene copolymer, and ethylene-propylene-butylene terpolymer, 35 to 45 wt % of adhesion enhancer of any one or two or more selected from the group consisting of petroleum-based resin, terpene-based resin, and rosin-based resin, and 5 to 10 wt % of softening oil of any one or two or more selected from the group consisting of aromatic oil, naphthenic oil and paraffin-based oil, but is not necessarily limited thereto.

The hot-melt adhesive is melted by being heated at 200° C. or higher, preferably 250 to 300° C., and then may be coated by the spray coating method using spray, and the one component type solvent type adhesive may be coated by the spray coating method using the spray, but the adhesives of the present invention are not necessarily limited thereto. When the spray coating is performed using the spray, small spot-like adhesives are formed on the surface of the non-woven fabric layer 30 or the polyolefin composite layer 40, thereby improving the adhesion without hindering the air permeability.

By dispersing the adhesive according to the present invention on the non-woven fabric layer 30 or the polyolefin composite layer 40 using the spray coating method, oxygen permeability may be maintained to the maximum, and the adhesion may be more improved than the existing lattice type bonding method, or the like.

The present invention prepares the air-permeable laminate insulation material including the insulation material layer 10, the aluminum coating layer 20 formed on one or both surfaces of the insulation material layer 10, the non-woven fabric layer 30 formed on the aluminum coating layer 20, and the polyolefin composite layer 40 which is laminated on the non-woven fabric layer 30, thereby preventing moisture or a drop of water from being permeated without the separate process of giving the air permeability and having the air permeability passing humidity and air and strengthening the tensile strength and the trapezoidal tear.

### Advantageous Effects

The air-permeable laminate insulation material according to the present invention may be prepared to have the excellent air permeability and strength.

Further, the air-permeable laminate insulation material may be prepared to keep the water-proof property and the insulation of buildings while preventing the condensation and passing the moisture.

### DESCRIPTION OF DRAWINGS

FIG. 1 is a diagram illustrating a structure of an air-permeable laminate insulation material formed on one surface in the present invention.

FIG. 2 is a diagram illustrating a structure of the air-permeable laminate insulation material formed on both surfaces in the present invention.

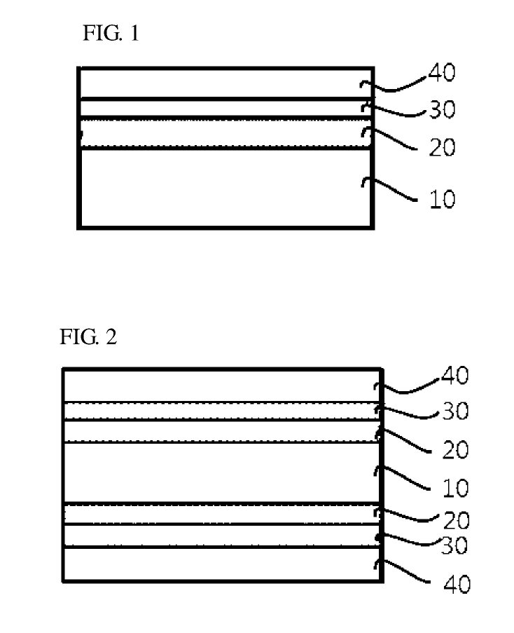

### DETAILED DESCRIPTION OF MAIN ELEMENTS

10: Insulation material layer

20: Aluminum coating layer

30: Non-woven fabric layer

40: Polyolefin composite layer

### BEST MODE

Hereinafter, the present invention will be described in more detail by way of examples, but the present invention is not limited to the following examples.

The following properties were measured by the following methods.

1) Tensile Properties
Strength and elongation at the time of breaking of a sample were each measured in a MD direction and a CD direction according to ASTM D5034.

2) Trapezoidal Tear
The tearing of the sample was each measured in the MD direction and the CD direction according to the ASTM D5733-95.

3) PEEL measurement of non-woven fabric layer and polyolefin composite layer
The size of the sample was set to be 25×150 cm in width x height according to the ASTM D 751 and then the MD direction of the sample was measured using a tensile tester (INSTRON).

4) Moisture Permeability
The amount of moisture passed through the film made according to ASTM E-96-96 for 24 hours per 1 m² was represented by g.

The air-permeable film was exposed for about 2 hours in a thermohygrostat of a temperature of 38° C. and a relative humidity of 90% and then the moisture absorption of calcium chloride which is generated by passing moisture through the air-permeable film was measured.

5) Resistance to Water Pressure
The resistance of the sample to permeation of liquefied water under a constant resistance to water pressure was measured using AATCC 127-1998.

In the physical property measurement of the present invention, the MD direction represents a running direction and the CD direction represents a width direction perpendicular to the running direction.

### EXAMPLE 1

After the insulation material layer was formed to have a basis weight of 170 g/m² by using an insulation material (air-permeable polyethylene_UPC (Co.), B-UP30, polypropylene non-woven fabric_UPC (Co.), NAP06003), a solution in which aluminum power (IDI Chemical, silver 2) is dispersed in thinner (Misung Chemical, P.E. thinner) was gravure printed on one surface of the insulation material layer to have a basis weight of 1.5 g/m² and then dried at 60° C. to form the aluminum coating layer on the insulation material layer.

As another process, 55 parts by weight of calcium carbonate (YABASHI KOREA, YK1C) with respect to 100 parts by weight of low density polyethylene (Hanwha Chemical, HANWHA LDPE 955, density: 0.913) was mixed and melted. The polyolefin composite layer was extruded in T-die by a film extruder and then uniaxially stretched 2.5 times at a stretching temperature of 70° C. to have a basis weight of 30 g/m².

As another process, the non-woven fabric layer was formed by being laminated in the multi-layer web on the belt continuously moving and thermally bonded so that it has a basis weight of 30 g/m² by spinning a polypropylene filament fiber. The produced polyolefin composite layer was laminated on the produced non-woven fabric, and then heated and pressed at a temperature of 170° C. and at a pressure of 75 kg/cm² to press and laminate the polyolefin composite layer on the non-woven fabric.

After the non-woven fabric layer surface of the laminated polyolefin composite layer and the non-woven fabric layer, and the aluminum coating layer surface of the aluminum coating layer formed on the insulation material layer faced each other, the air-permeable laminate insulation material was prepared by the heating and pressing at a temperature of 170° C. and a pressure of 78 kg/cm².

### EXAMPLE 2

After the insulation material layer was formed to have a basis weight of 170 g/m² by using an insulation material (air-permeable polyethylene_UPC (Co.), B-UP30, polypropylene non-woven fabric_UPC (Co.), NAP06003), a solution in which aluminum power (IDI Chemical, silver 2) is dispersed in thinner (Misung Chemical, P.E. thinner) was gravure printed on one surface of the insulation material layer to have a basis weight of 1.5 g/m² and then dried at 60° C. to form the aluminum coating layer on the insulation material layer.

As another process, 55 parts by weight of calcium carbonate (YABASHI KOREA, YK1C) with respect to 100 parts by weight of low density polyethylene (Hanwha Chemical, HANWHA LDPE 955, density: 0.913) was mixed and melted. The polyolefin composite layer was extruded in the T-die by the film extruder and then uniaxially stretched 2.5 times at a stretching temperature of 70° C. to have a basis weight of 30 g/m².

As another process, the non-woven fabric layer was formed by being laminated in the multi-layer web on the belt continuously moving and thermally bonded so that it has a basis weight of 30 g/m² by spinning a polypropylene filament fiber. A polyurethane adhesive (Sungdo Chemical, D-9800) was coated on the produced polyolefin composite layer by the gravure roll coating method to have a basis weight of 5 g/m² and the produced non-woven fabric was laminated on the polyolefin composite layer and then passed through the pressing roller to press and laminate the polyolefin composite layer on the non-woven fabric.

After the non-woven fabric layer surface of the laminated polyolefin composite layer and the non-woven fabric layer, and the aluminum coating layer surface of the aluminum coating layer formed on the insulation material layer faced each other, the air-permeable laminate insulation material was prepared by the heating and pressing.

### EXAMPLE 3

Example 3 was performed by the same method as the above Example 2 except that polyurethane adhesive (Sungdo chemical, D-9800) was coated on the polyolefin composite layer produced in the above Example 2 by the spray, thereby preparing the air-permeable laminate insulation material.

### EXAMPLE 4

After the insulation material layer was formed to have a basis weight of 170 g/m² by using an insulation material (air-permeable polyethylene_UPC (Co.), B-UP30, polypropylene non-woven fabric_UPC (Co.), NAP06003), a solution in which aluminum power (IDI Chemical, silver 2) is dispersed in thinner (Misung Chemical, P.E. thinner) was gravure printed on both surfaces of the insulation material layer to have a basis weight of 3 g/m² and then dried at 60° C. to form the aluminum coating layer on the insulation material layer.

As another process, 55 parts by weight of calcium carbonate (YABASHI KOREA, YK1C) with respect to every 100 parts by weight of low density polyethylene (Hanwha Chemical, HANWHA LDPE 955, density: 0.913) was mixed and melted. The polyolefin composite layer was extruded in the T-die by the film extruder and then uniaxially stretched 2.5 times at a stretching temperature of 70° C. to have a basis weight of 30 g/m².

As another process, the non-woven fabric layer was formed by being laminated in the multi-layer web on the belt continuously moving and thermally bonded so that it has a basis weight of 30 g/m² by spinning a polypropylene filament fiber. A polyurethane adhesive (Sungdo Chemical, D-9800) was coated on the produced polyolefin composite layer by the gravure roll coating method to have a basis weight of 5 g/m² and the produced non-woven fabric was laminated on the polyolefin composite layer and then passed through the pressing roller to press and laminate the polyolefin composite layer on the non-woven fabric.

After and the non-woven fabric layer surface of the laminated air-permeable adhesive layer the non-woven fabric layer, and the aluminum coating layer surface of the aluminum coating layer formed on the insulation material layer faced each other, the air-permeable laminate insulation material was prepared by the heating and pressing.

### COMPARATIVE EXAMPLE 1

The insulation material layer was formed so as to have a basis weight of 170 g/m² by using the insulation material (air-permeable polyethylene_UPC (Co.), B-UP30, polypropylene non-woven fabric_UPC (Co.), NAP06003).

As another process, 55 parts by weight of calcium carbonate (YABASHI KOREA, YK1C) with respect to 100 parts by weight of low density polyethylene (Hanwha Chemical, HANWHA LDPE 955, density: 0.913) was mixed and melted. The polyolefin composite layer was extruded in the T-die by the film extruder and then uniaxially stretched 2.5 times at a stretching temperature of 70° C. to have a basis weight of 30 g/m².

As another process, the non-woven fabric layer was formed by being laminated in the multi-layer web on the belt continuously moving and thermally bonded so that it has a basis weight of 30 g/m² by spinning a polypropylene filament fiber. The produced polyolefin composite layer was laminated on the produced non-woven fabric layer, and then heated and pressed at a temperature of 170° C. and at a pressure of 75 kg/cm² to press and laminate the polyolefin composite layer on the non-woven fabric.

After the non-woven fabric layer surface of the laminated polyolefin composite layer and the non-woven fabric layer, and the insulation material layer surface faced each other, the air-permeable laminate insulation material was prepared by the heating and pressing at a temperature of 170° C. and a pressure of 75 kg/cm².

### COMPARATIVE EXAMPLE 2

The insulation material layer was formed so as to have a basis weight of 170 g/m² by using the insulation material (air-permeable polyethylene_UPC (Co.), B-UP30, polypropylene non-woven fabric_UPC (Co.), NAP06003).

As another process, 55 parts by weight of calcium carbonate (YABASHI KOREA, YK1C) with respect to 100 parts by weight of low density polyethylene (Hanwha Chemical, HANWHA LDPE 955, density: 0.913) was mixed and melted. The polyolefin composite layer was extruded in the T-die by the film extruder and then uniaxially stretched 2.5 times at a stretching temperature of 70° C. to have a basis weight of 30 g/m².

As another process, the non-woven fabric layer was formed by being laminated in the multi-layer web on the belt continuously moving and thermally bonded so that it has a basis weight of 30 g/m² by spinning a polypropylene filament fiber. A polyurethane adhesive (Sungdo Chemical, D-9800) was coated on the produced polyolefin composite layer by the gravure roll coating method to have a basis weight of 5 g/m² and the produced non-woven fabric was laminated on the polyolefin composite layer and then passed through the pressing roller to press and laminate the polyolefin composite layer on the non-woven fabric.

After the non-woven fabric layer surface of the laminated air-permeable adhesive layer and the non-woven fabric layer, and the insulation material layer surface faced each other, the air-permeable laminate insulation material was prepared by the heating and pressing at a temperature of 170° C. and a pressure of 75 kg/cm².

TABLE 1

| | | | | | | Comparative | Comparative |
|---|---|---|---|---|---|---|---|
| | | Example 1 | Example 2 | Example 3 | Example 4 | Example 1 | Example 2 |
| Basic Weight (g) | | 74 | 75 | 75 | 76 | 73 | 74 |
| Tensile Strength | MD | 11 | 12 | 14 | 15 | 9 | 10 |
| (kgf/2 inch) | CD | 4 | 5 | 6 | 6 | 3 | 4 |
| Breaking Strength | MD | 16 | 17 | 20 | 20 | 13 | 14 |
| (kgf/2 inch) | CD | 7 | 8 | 9 | 10 | 6 | 6 |
| Elongation | MD | 80 | 95 | 100 | 80 | 65 | 70 |
| (%) | CD | 95 | 110 | 120 | 95 | 80 | 105 |
| Trapezoidal Tear | MD | 8 | 8 | 11 | 13 | 7 | 7.5 |
| (kg) | CD | 3 | 4 | 5 | 6 | 3 | 4 |

| | | | | | | |
|---|---|---|---|---|---|---|
| Peel | 350 | 540 | 540 | 500 | 300 | 320 |
| Moisture Permeability | 5700 | 6000 | 6100 | 5700 | 5800 | 5700 |
| (g/uf, 24 hr) | | | | | | |
| Resistance to | 250 | 270 | 270 | 300 | 220 | 230 |
| Water Pressure (cu) | | | | | | |

From Table 1, it was confirmed that the air-permeable laminate insulation material includes the aluminum coating layer formed on one surface or both surfaces to keep the moisture permeability and improve the tensile strength, the breaking strength, the elongation, the trapezoidal tear, and the water permeation resistance.

1. An air-permeable laminate insulation material, comprising:
an insulation material layer;
an aluminum coating layer formed on one or both surfaces of the insulation material layer;
a non-woven fabric layer formed on the aluminum coating layer; and
a polyolefin composite layer which is made from a mixture of polyolefin resin and inorganic particles and laminated on the non-woven fabric layer.

2. The air-permeable laminate insulation material of claim 1, wherein the polyolefin composite layer has air permeability by producing an extrusion sheet including 10 to 200 parts by weight of inorganic particles with respect to 100 parts by weight of the polyolefin resin and stretching the extrusion sheet.

3. The air-permeable laminate insulation material of claim 1, wherein an air-permeable adhesive layer is further included between the non-woven fabric layer and the polyolefin composite layer.

4. The air-permeable laminate insulation material of claim 3, wherein the air-permeable adhesive layer has a coated portion and an uncoated portion of an adhesive by spray coating or gravure roll coating the adhesive to have air permeability.

5. The air-permeable laminate insulation material of claim 1, wherein the aluminum coating layer is produced by coating or depositing a solution including an aluminum particle.

6. The air-permeable laminate insulation material of claim 5, wherein the coating is performed by screen coating or gravure roll coating.

7. The air-permeable laminate insulation material of claim 1, wherein the insulation material of the insulation material layer is one or two or more selected from cotton, needle punching non-woven fabric, plastic foam, melt blown non-woven fabric, fiber fabric, and woven fabric.

8. The air-permeable laminate insulation material of claim 1, wherein the insulation material layer has a basis weight of 25 to 800 g/m², the aluminum coating layer has a basis weight of 1 to 80 g/m², the non-woven fabric layer has a basis weight of 10 to 60 g/m², and the polyolefin composite layer has a basis weight of 10 to 100 g/m².

9. The air-permeable laminate insulation material of claim 3, wherein the air-permeable adhesive layer has a basis weight of 1 to 10 g/m².
